(19) United States
(12) Patent Application Publication
(10) Pub. No.: US 2011/0210975 A1
(43) Pub. Date: Sep. 1, 2011

(54) MULTI-SCREEN SIGNAL PROCESSING DEVICE AND MULTI-SCREEN SYSTEM

(75) Inventors: Hung-Sheng Wong, Hsinchu City (TW); Ching-Chang Shih, Hsinchu City (TW)

(73) Assignee: XGI TECHNOLOGY, INC., Hsinchu City (TW)

(21) Appl. No.: 12/713,504

(22) Filed: Feb. 26, 2010

(51) Int. Cl. G06F 15/16; G09G 5/00

(52) U.S. Cl. 345/503; 345/1.3

(57) ABSTRACT

A multi-screen signal processing device includes a main graphics processor and a plurality of sub-graphics processors. The main graphics processor is electrically connected to the plurality of sub-graphics processors respectively. The main graphics processor is used for receiving an external image data, and capable of decoding the external image data and outputting a frame data. Each sub-graphics processor respectively captures a part of the frame data synchronously and outputs a broadcasting signal. The multi-screen signal processing device may be connected to multiple screens to play multiple images at the same time. Moreover, the decoding step using a single graphics processor enables easy synchronization of frames displayed on different screens and saves energy consumed by repeating the decoding step.

### BACKGROUND

1. Field of Invention

The present invention relates to a processing device, and more particularly to a multi-screen signal processing device and a multi-screen system.

2. Related Art

A multi-screen display system has been widely applied in various situations. For example, multiple screens are combined into a large-scale television (TV) wall panel for displaying information or advertisements in a public place.

FIG. 1 is a system block diagram of a prior art, which provides a computer system including a central processing unit (CPU) 81, a north bridge chip 82, and multiple graphics processors 83.

The CPU 81 is connected to external elements through the north bridge chip 82. The multiple graphics processors 83 may be inserted in expansion slots and connected to the north bridge chip 82 through a peripheral component interconnect (PCI) or an accelerated graphics port (AGP). Each graphics processor 83 is individually connected to a display screen. The CPU 81 transfers image data to the multiple graphics processors 83 one by one. The graphics processors 83 respectively decode the image data and capture displayed frames. The computer may output frames to multiple screens through the architecture in which the multiple graphics processors 83 are connected at the same time.

However, a general computer main board has a limited number of expansion slots. That is, the number of screens that can be connected to the computer is also limited. In addition, since each graphics processor performs the image decoding step respectively and image decoding requires a large amount of operation, it is difficult to output an image signal of each graphics processor synchronously. Moreover, the simultaneous image decoding by each graphics processor also causes much energy consumption.

Moreover, another prior art using a bridging interface is also presented. FIG. 2 is a system block diagram of a processing device of a multi-screen display system in the prior art. The system includes a CPU 81, a north bridge chip 82, multiple graphics processors 83, and a bridging interface 84. The multiple graphics processors 83 are connected via the bridging interface 84, so as to expand the number of the graphics processors 83.

However, the use of the bridging interface 84 results in a complex system and greatly increases the cost. Besides, the multiple graphics processors 83 still need to perform decoding individually, so that the energy consumption caused by repeated decoding is still a problem to be solved.

### SUMMARY

Accordingly, the present invention is a multi-screen signal processing device for solving the problems of limited number of screens, difficulty in synchronization, and system complexity.

The present invention provides a multi-screen signal processing device, which comprises a main graphics processor and a plurality of sub-graphics processors. The main graphics processor is electrically connected to the plurality of sub-graphics processors respectively.

The main graphics processor is used for receiving an external image data, and capable of decoding the external image data and outputting a frame data with a size of a visual range. Each of the sub-graphics processors respectively captures a part of the frame data synchronously and outputs a broadcasting signal.

The main graphics processor and the multiple sub-graphics processors are located on the same circuit board. The circuit board may be a printed circuit board (PCB).

The multi-screen signal processing device provided in the present invention may be used in a personal computer (PC), and is connected to multiple screens at the same time without the limitation of the number of expansion slots. Moreover, the decoding step using only a single graphics processor not only enables easy synchronization of frames displayed on different screens, but also saves energy consumed by repeating the decoding step and greatly reduces the required system resources.

### BRIEF DESCRIPTION OF THE DRAWINGS

The present invention will become more fully understood from the detailed description given herein below for illustration only, and thus are not limitative of the present invention, and wherein:

FIGS. 1 and 2 are respectively a system block diagram of a processing device of a multi-screen display system in the prior art;

FIG. 3 is a block diagram of an embodiment of the present invention;

FIG. 4 is a schematic view illustrating sizes of a broadcasting signal and a frame data in the present invention;

FIG. 5 is a stereogram of the appearance of a multi-screen signal processing device in an embodiment of the present invention;

FIG. 6 is a schematic view illustrating capturing of the frame data in an embodiment of the present invention; and

FIG. 7 is a schematic view of an implementation of the present invention.

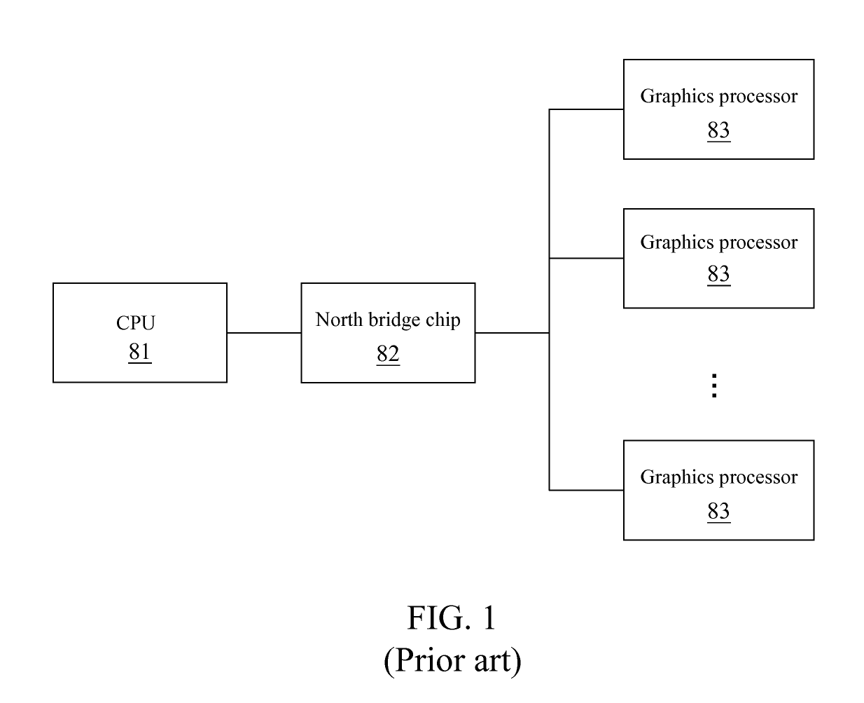

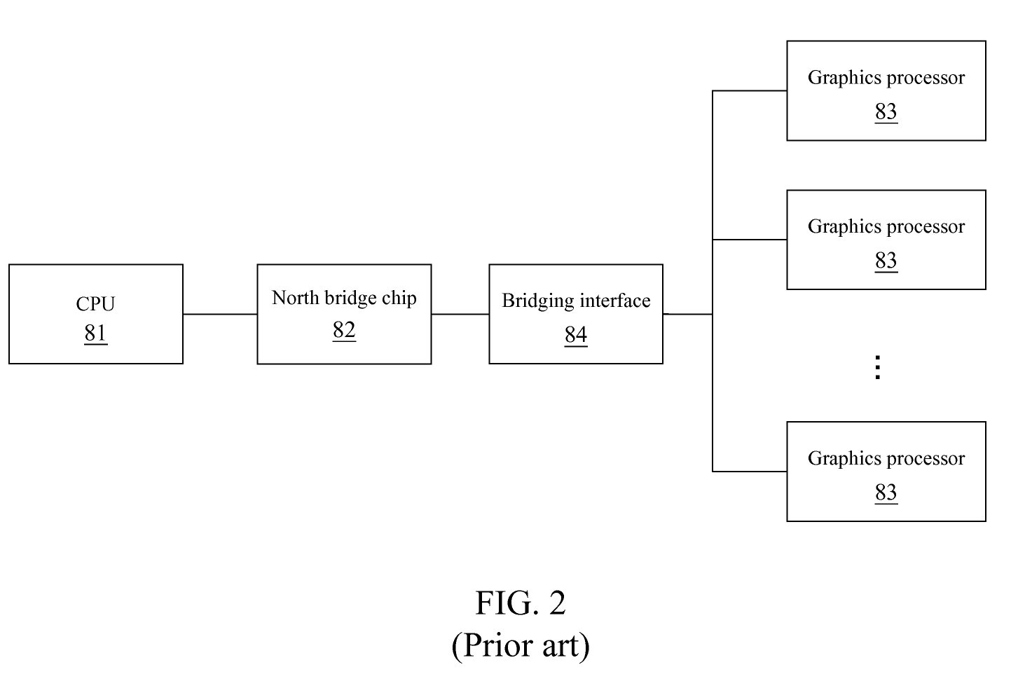

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention. The following embodiments are intended to describe the present invention in further detail, but not intended to limit the scope of the present invention in any way.

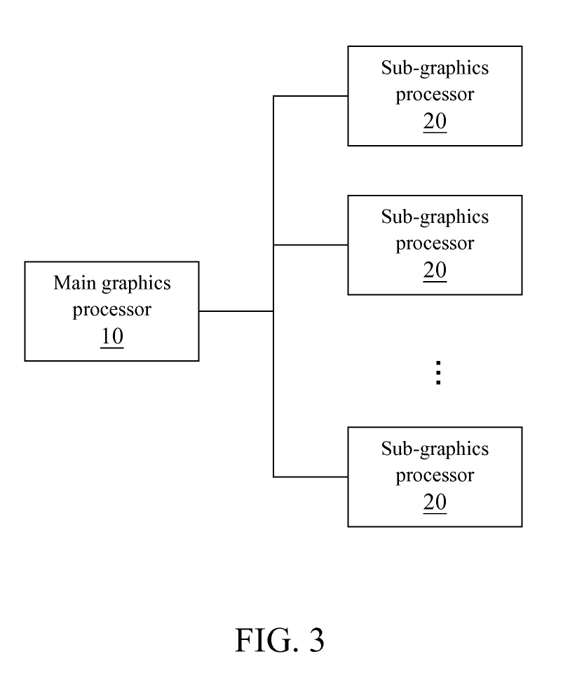

FIG. 3 is a block diagram of an embodiment of the present invention. A multi-screen signal processing device provided in the present invention comprises a main graphics processor 10 and a plurality of sub-graphics processors 20. The main graphics processor 10 is electrically connected to the plurality of sub-graphics processors 20 respectively.

The main graphics processor 10 is used for receiving an external image data, and capable of decoding the external image data and outputting a frame data with a size of a visual frame. The visual frame is an area where image data is actually stored. Generally speaking, the size of the visual frame is a resolution of a display screen. For example, a display screen with a resolution of 1920×1200 is corresponding to a visual frame with a size of 1920×1200.

The external image data is in a compressed image format, for example, H.264 or Moving Picture Experts Group 2 (MPEG2). That is, the main graphics processor 10 performs the decoding step corresponding to the above format. In addition, the main graphics processor 10 may further perform a synthesis step on the image, for example, to synthesize the image and a caption into a new image.

Each sub-graphics processor 20 respectively captures a part of the frame data synchronously and outputs a broadcasting signal with a size of a specification range.

The main graphics processor 10 and the plurality of sub-graphics processors 20 may be connected to each other via a digital video output (DVO) interface. The main graphics processor 10 and the plurality of sub-graphics processors 20 are electrically connected to a peripheral component interconnect (PCI) bus or a peripheral component interconnect express (PCIE) bus.

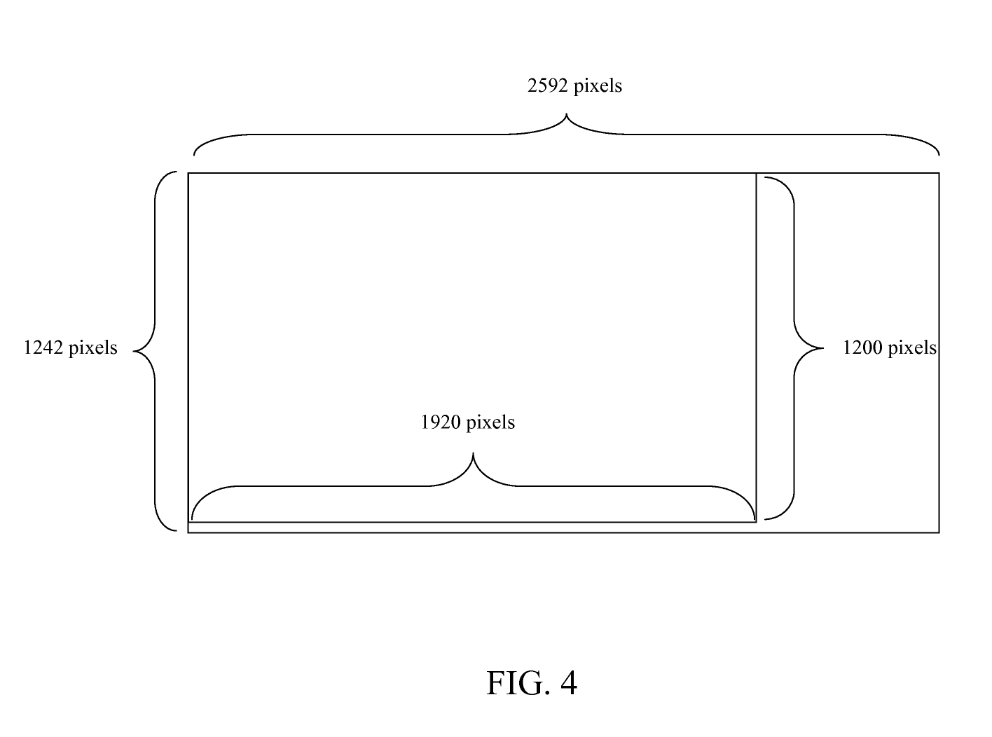

FIG. 4 is a schematic view illustrating sizes of the broadcasting signal and the frame data. The size of the broadcasting signal may follow to a video signal standard developed by the Video Electronics Standards Association (VESA). For example, for a 1920×1200 frame, total pixels in a horizontal axis are a horizontal visual range (1920 pixels) plus a horizontal blank range (672 pixels), i.e., altogether 2592 pixels. The horizontal visual range is used for storing data displayed on the frame, and the horizontal blank range is used for providing the time required for TV scanning and column shifting. Similarly, total pixels in a vertical axis are a vertical visual range (1200 pixels) plus a vertical blank range (42 pixels), i.e., altogether 1242 pixels. The vertical visual range is used for storing data displayed on the frame, and the vertical blank range is used for providing the time required for TV scanning and row shifting.

Based on the above, although the size of a broadcasting signal is 2592×1242 pixels, the size thereof actually stored with a visual frame is only 1920×1200 pixels. That is, in the broadcasting signal, only about 70 percent of the pixels are actually stored with data, and the other 30 percent of the pixels are only stored with blank data.

In addition, a frame rate of the broadcasting signal is 60 Hz under the standard developed by the VESA, while a frame rate of a general image format is only 24 Hz. That is, a general image can be displayed completely as long as information with a frame rate of 24 Hz is kept.

Therefore, after receiving and decoding the external image data, the main graphics processor 10 only transfers data with a size of a visual frame to the sub-graphics processors 20, and performs down-sampling on the decoded frame data, i.e., to convert the frame rate of 60 Hz to 24 Hz.

Furthermore, the broadcasting signal has a size of 2592×1242 pixels and a frame rate of 60 Hz, so a pixel clock corresponding to the broadcasting signal is about 193 MHz. In another aspect, the frame data in which only a visual range is captured has a size of 1920×1200 pixels and a frame rate reduced to 24 Hz. At this time, a pixel clock corresponding to the frame data is only about 56 MHz, i.e., about 30% of the original pixel clock. As a result, a required bandwidth between the main graphics processor 10 and the sub-graphics processors 20 only needs to be about 30% of the original bandwidth. The system resources required by the multi-screen signal processing device can be greatly reduced through the frame data in which only a visual range is captured and down-sampling.

Each sub-graphics processor 20 captures the frame data synchronously according to a memory position where the frame data is stored. Each sub-graphics processor 20 amplifies the captured frame data and then performs up-sampling on the captured data, i.e., to convert the frame rate of 24 Hz to 60 Hz. Finally, each sub-graphics processor 20 outputs a broadcasting signal to multiple screens.

At this time, since the broadcasting signal is the signal actually transferred to the screen, the broadcasting signal needs to be a signal that can be received by the screen. That is, the size of the broadcasting signal shall follow to the video signal standard developed by the VESA.

At this time, since the broadcasting signal is the signal actually transferred to the screen, the broadcasting signal needs to be a signal that can be received by the screen. That is, the size of the broadcasting signal shall follow to the video signal standard developed by the VESA.

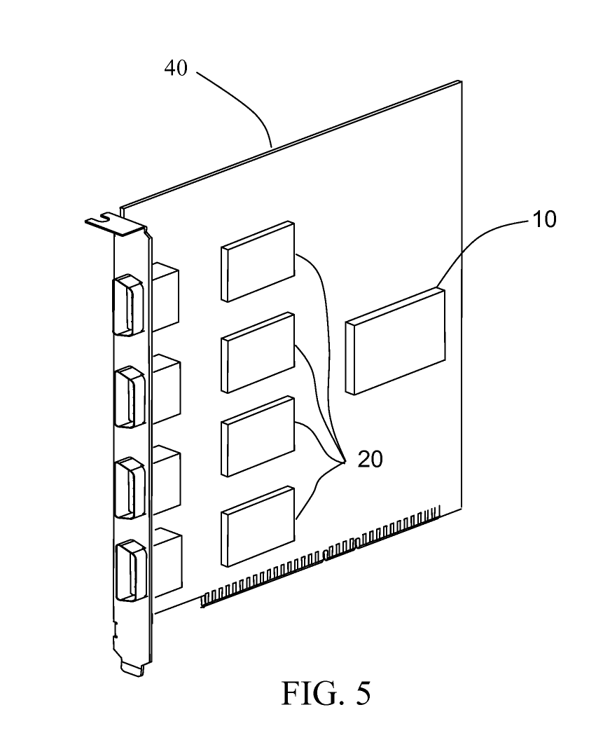

FIG. 5 is a stereogram of the appearance of the multi-screen signal processing device in an embodiment of the present invention. The main graphics processor 10 and the multiple sub-graphics processors 20 may be located on the same circuit board 40. The circuit board 40 may be a display card.

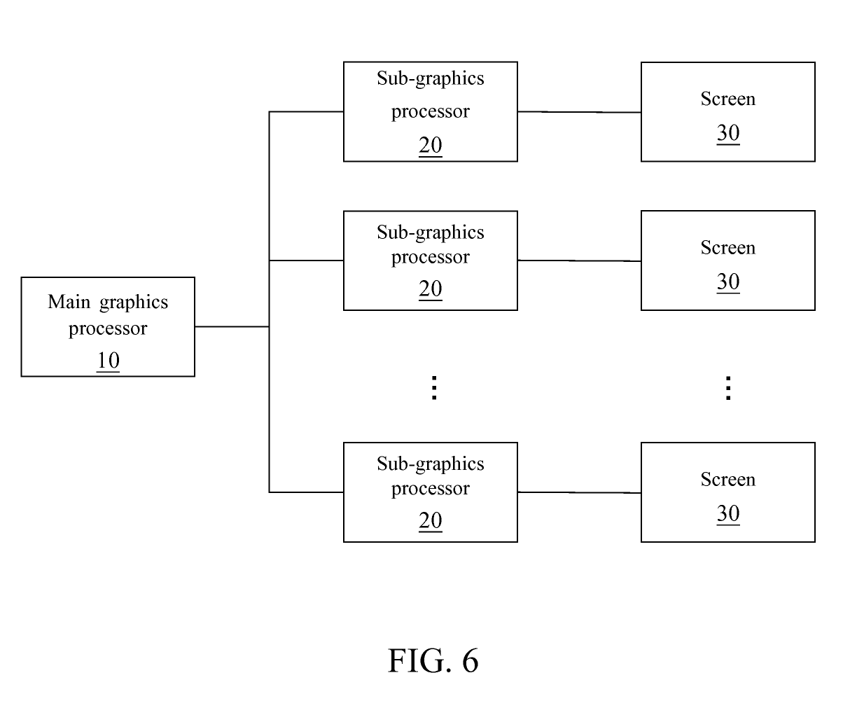

The multi-screen signal processing device provided in the present invention may be applied in a multi-screen system. Referring to FIG. 6, the multi-screen system comprises a main graphics processor 10, a plurality of sub-graphics processors 20, and a plurality of screens 30. The main graphics processor 10 is electrically connected to the plurality of sub-graphics processors 20 respectively. The plurality of screens 30 is electrically connected one-to-one to the plurality of sub-graphics processors 20.

The plurality of screens 30 may be, but is not limited to, liquid crystal display (LCD) screens, plasma display screens, light-emitting diode (LED) display screens, cathode-ray tube (CRT) display screens, or other devices capable of playing images. The plurality of screens 30 may be arranged into a quadrilateral screen array, for example, a 2×2 or 3×3 array. At this time, if four 50-inch display screen arrays are arranged in the 2×2 manner, the screen array obtained after the arrangement may be regarded as a 100-inch screen.

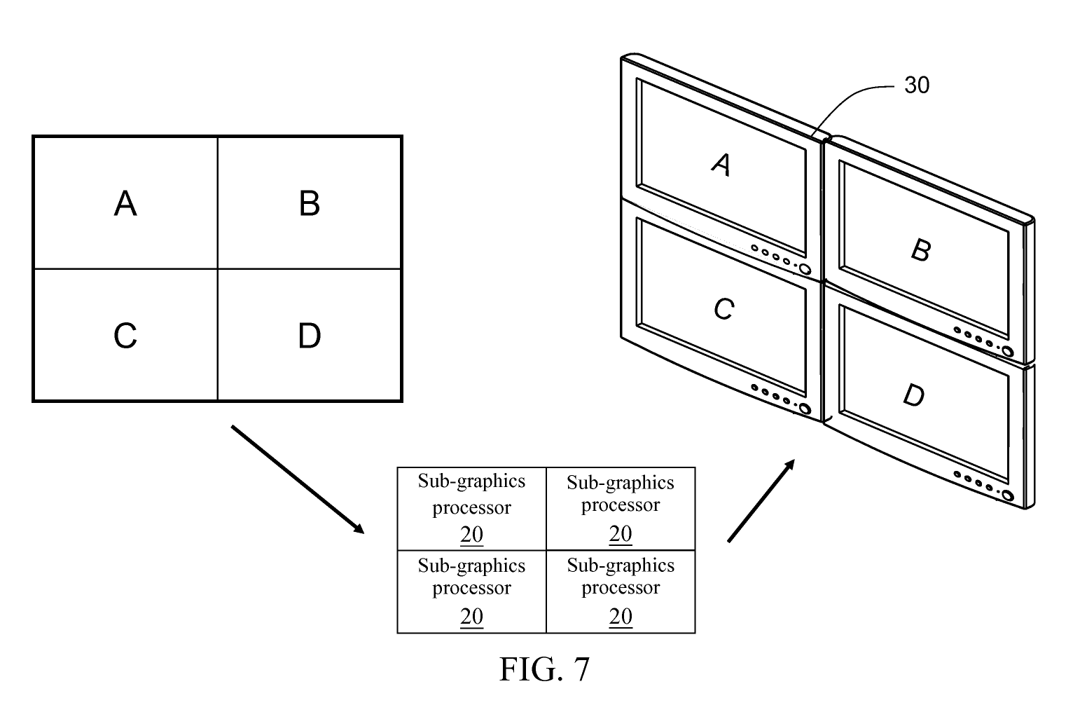

FIG. 7 is a schematic view of an implementation of the present invention. Herein, for example, one main frame is divided into four sub-frames (A, B, C, and D) and displays are arranged in the 2×2 manner. After an external image data is supplied into the multi-screen signal processing device, the main graphics processor 10 decodes the main frame first. Then, the sub-graphics processors 20 respectively capture four sub-frames (A, B, C, and D). Each graphics processor 20 respectively amplifies each sub-frame to a frame displayable on the screen 30 and supplies the sub-frame to each screen 30 for playing. The screens 30 arranged in the 2×2 manner can respectively play the four sub-frames (A, B, C, and D), so as to achieve the efficacy of playing frames in an amplified form.

The multi-screen signal processing device provided in the present invention may be used in a PC, and is connected to multiple screens at the same time without the limitation of the number of expansion slots. Moreover, the decoding step using only a single graphics processor not only enables easy synchronization of frames displayed on different screens, but also saves energy consumed by repeating the decoding step and greatly reduces the required system resources.

What is claimed is:

1. A multi-screen signal processing device, comprising:
a main graphics processor, for receiving an external image data and decoding the external image data to output a frame data; and
a plurality of sub-graphics processors, electrically connected to the main graphics processor, wherein each of the sub-graphics processors respectively captures a part of the frame data synchronously and outputs a broadcasting signal.

2. The multi-screen signal processing device according to claim 1, wherein the main graphics processor and the plurality of sub-graphics processors are located on the same circuit board.

3. The multi-screen signal processing device according to claim 2, wherein the circuit board is a printed circuit board (PCB).

4. The multi-screen signal processing device according to claim 1, wherein the main graphics processor and the plurality of sub-graphics processors are electrically connected to a peripheral component interconnect (PCI) bus or a peripheral component interconnect express (PCIE) bus.

5. The multi-screen signal processing device according to claim 1, wherein a size of the broadcasting signal follows to a video signal standard developed by the Video Electronics Standards Association (VESA).

6. The multi-screen signal processing device according to claim 1, wherein a size of the frame data is a size of a visual frame.

7. The multi-screen signal processing device according to claim 1, wherein the main graphics processor performs a down-sampling processing on the decoded frame data.

8. The multi-screen signal processing device according to claim 1, wherein the main graphics processor performs a up-sampling processing on the captured frame data.

9. A multi-screen system, comprising:
a main graphics processor, for receiving an external image data and decoding the external image data to output a frame data;
a plurality of sub-graphics processors, electrically connected to the main graphics processor, wherein each of the sub-graphics processors respectively captures a part of the frame data synchronously and outputs a broadcasting signal; and
a plurality of display screens, electrically connected one-to-one to the plurality of sub-graphics processors.

10. The multi-screen system according to claim 9, wherein the main graphics processor and the plurality of sub-graphics processors are located on the same circuit board.

11. The multi-screen system according to claim 10, wherein the circuit board is a printed circuit board (PCB).

12. The multi-screen system according to claim 9, wherein the main graphics processor and the plurality of sub-graphics processors are electrically connected to a peripheral component interconnect (PCI) bus or a peripheral component interconnect express (PCIE) bus.

13. The multi-screen system according to claim 9, wherein a size of the broadcasting signal follows to a video signal standard developed by the Video Electronics Standards Association (VESA).

14. The multi-screen system according to claim 9, wherein a size of the frame data is a size of a visual frame.

15. The multi-screen system according to claim 9, wherein the main graphics processor performs down-sampling on the decoded frame data.

16. The multi-screen system according to claim 9, wherein the main graphics processor performs up-sampling on the captured frame data.
